(19) United States
(12) Patent Application Publication
(10) Pub. No.: US 2005/0210288 A1
(43) Pub. Date: Sep. 22, 2005

(54) Method and apparatus for eliminating dual authentication for enterprise access via wireless LAN services

(76) Inventor: Eric Henry Grosse, Berkeley Heights, NJ (US)

Correspondence Address: Lucent Technologies Inc., Docket Administrator (Room 3J-219), 101 Crawfords Corner Road, Holmdel, NJ, 07733-3030, US

(21) Appl. No.: 10/805,889

(22) Filed: Mar. 22, 2004

(51) Int. Cl. H04L 9/00

(52) U.S. Cl. 713/201

(57) ABSTRACT

A method and apparatus for the operation of a network access server (e.g., at a wireless LAN hotspot) advantageously eliminates the need for dual authentication by an enterprise employee who connects to a Virtual Private Network (VPN) of the enterprise or other enterprise-authenticated host. The need for an enterprise user to have an account with a network access (e.g., a wireless LAN hotspot) service provider and to be billed individually is advantageously eliminated. Specifically, the network access server provides, without authentication, limited access to the Internet—to wit, access to, for example, the VPN gateway(s) of the user's enterprise VPN, or alternatively, access to the VPN gateway(s) of all enterprises which have established a relationship with the service provider. Advantageously, no additional software is required to be resident on the user's terminal (e.g., a laptop computer).

### FIELD OF THE INVENTION

The present invention relates generally to the field of wireless LAN (Local Area Network) services provided with use of, for example, “Wi-Fi” (the IEEE 802.11 wireless standard protocol), and more particularly to a method and apparatus for use by enterprise users whereby dual authentication requirements are advantageously eliminated.

### BACKGROUND OF THE INVENTION

Over the last few years, wireless LAN (Local Area Network) services, such as those provided with use of, for example, “Wi-Fi” (the IEEE 802.11 wireless standard protocol, fully familiar to those of ordinary skill in the art), have become enormously popular and commonplace. From coffee houses to airport lounges, wireless LAN service “hotspots” have sprung up everywhere and wireless access to the Internet is becoming almost ubiquitous.

Although a few of these wireless LAN service hotspots provide open and unrestricted network access to the Internet, being freely available to anyone who is within the necessary geographical area (typically on the order of a few hundred feet), most of these hotspots provide instead a fee-based service. In particular, for an individual user to make use of a hotspot (i.e., wirelessly connect to the Internet), when the hotspot is fee-based and operated by a particular wireless LAN service provider, it is necessary to have a (previously established) account with that specific service provider. Then, any and all wireless LAN use by the given user is charged to his or her account with that service provider.

Typically, establishing such an account with a wireless LAN service provider requires that the user provides credit card information (so that the given credit card can be charged for all account usage). In addition, the user will select (or be provided with) a unique user-name and a corresponding password, which is presumably unknown to others. Thus, when the user wishes to connect to the Internet through one of the given service provider's hotspots, he or she “signs on” to the wireless LAN by providing his or her user-name and corresponding password, thus authenticating that he or she is the authorized individual (who is associated with the given previously established account). From this point on, all usage of the network by the user will be advantageously charged to his or her account (e.g., to the provided credit card).

Meanwhile, most enterprises (large corporations or other large organizations) have their own internal network (an “Intranet”), typically referred to as a “Virtual Private Network” or VPN, and many employees of these enterprises need frequent access to within the enterprise's VPN even when they are away from their home or office. In fact, when traveling on business, it is common for such enterprise employees to use such wireless LAN hotspots (e.g., hotspots in airport lounges) solely to access their company's VPN, and then to access any general Internet sites (i.e., those not internal to the enterprise's Intranet) from within the VPN. (This ensures that all of the user's access to the Internet is made from within the enterprise's “firewall,” thereby providing the same level of security for the user as if he or she were physically “inside” the enterprise's Intranet. Note that the operation of Virtual Private Networks and firewalls are fully familiar to those of ordinary skill in the art.) However, to use such wireless LAN hotspots freely, each of these employees necessarily needs an individual account with each of the different wireless LAN hotspot service operators, which not only becomes quite cumbersome, but also requires each such employee to use either a personal or corporate credit card for the charges incurred.

And finally, note that it is universal that a VPN will require a user to “sign on” (i.e., provide a unique user-name and corresponding password to the VPN “gateway”) in order to be authenticated to gain access to the VPN—otherwise, the VPN would not be “private” (i.e., accessible only to authorized employees of the enterprise). Therefore, an enterprise employee who wishes to access his or her enterprise's VPN from a wireless LAN hotspot must necessarily “sign on” (be authenticated) twice—once to gain access to the wireless LAN hotspot service (and to enable the billing therefor), and once to gain access to the enterprise's VPN itself. This, especially in combination with the aforementioned fact that the user may need to use different user-names and corresponding passwords depending on the particular wireless LAN hotspot service provider at the given location, is obviously cumbersome and highly undesirable.

### SUMMARY OF THE INVENTION

The present invention provides a method and apparatus which advantageously eliminates the aforementioned dual authentication requirement whenever, for example, an enterprise employee wishes to connect to a Virtual Private Network (VPN) or other authenticated enterprise service. The present invention also advantageously eliminates the need for such an enterprise user to have a personal account with the wireless LAN hotspot service (or other network access service) provider. As such, the present invention also advantageously eliminates the need for a wireless LAN hotspot service (or other network access service) provider to bill each user of a given enterprise individually—rather, a single account between the service provider and the enterprise may be advantageously billed for all network access by all of the given enterprise's employees.

In particular, in accordance with certain illustrative embodiments of the present invention, the hotspot (or other network access) server provides, without authentication, limited access to the network (e.g., the Internet), such as, for example, access to the VPN gateway(s) of the user's enterprise VPN (or to other enterprise-authenticated hosts), or, alternatively, access to the VPN gateway(s) (or to other enterprise-authenticated hosts) of all enterprises which have established a relationship with the service provider. Finally, note that the present invention advantageously achieves all of this without the requirement of any additional software being resident on the user's laptop computer (or other user terminal).

Specifically, the present invention provides a method and apparatus for establishing a connection from a user terminal to a network through a network access server, comprising steps or means for (i) receiving a request from the user terminal to access the network with use of the network access server, and (ii) providing limited network access to the user terminal through the network access server, where the limited network access allows network connectivity between the user terminal and one or more predetermined enterprise-authenticated hosts through said network access server, but does not allow network connectivity between the user terminal and network sites other than those predetermined enterprise-authenticated hosts.

In accordance with various illustrative embodiments of the present invention, the user terminal may, for example, comprise a laptop or notebook computer, a Personal Digital Assistant, or other (typically portable) network-capable device, whether or not it is connectable to the network wirelessly (e.g., using the IEEE 802.11 standard protocol) or by a conventional wired connection. Also, in accordance with various illustrative embodiments of the present invention, the authenticated-enterprise host may, for example, comprise a VPN gateway of an enterprise's Virtual Private Network, or may comprise another secure (i.e., authenticated) enterprise service. Similarly, the enterprise-authenticated hosts may, for example, comprise enterprise VPN gateways or other hosts such as, for example, an “HTTPS” server (fully familiar to those of ordinary skill in the art). Finally, in accordance with various illustrative embodiments of the present invention, the network access server may, for example, comprise a wireless LAN hotspot server, or may be a server connected by wire to a conference room or hotel room that supplies (e.g., fee-based) guest network access.

### BRIEF DESCRIPTION OF THE DRAWINGS

FIG. 1 shows an example of a network configuration in which an illustrative embodiment of the present invention may be advantageously implemented.

FIG. 2 shows a flowchart of a prior art method executed by a user for establishing a network connection to a Virtual Private Network through a wireless LAN hotspot.

FIG. 3 shows a flowchart of a method executed by a user for establishing a network connection from to a Virtual Private Network through a wireless LAN hotspot operating in accordance with a first illustrative embodiment of the present invention.

FIG. 4 shows a flowchart of a method of operation of a wireless LAN hotspot server operating in accordance with the first illustrative embodiment of the present invention.

FIG. 5 shows a flowchart of a method executed by a user for establishing a network connection to a Virtual Private Network through a wireless LAN hotspot operating in accordance with a second illustrative embodiment of the present invention.

FIG. 6 shows a flowchart of a method of operation of a wireless LAN hotspot server operating in accordance with the second illustrative embodiment of the present invention.

### DETAILED DESCRIPTION OF THE ILLUSTRATIVE EMBODIMENTS

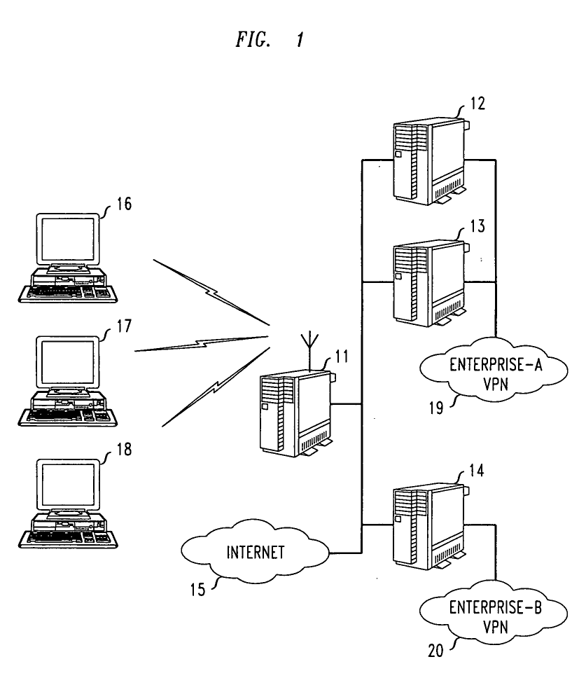

FIG. 1 shows an example of a network configuration in which an illustrative embodiment of the present invention may be advantageously implemented. The illustrative network configuration comprises wireless LAN server 11, operated by a given wireless LAN hotspot (e.g., IEEE 802.11) service provider and enabling a plurality of users having portable computing systems (e.g., laptop or notebook computers, Personal Data Assistants, etc.) to connect to the Internet through a wireless connection to server 11. (For illustrative purposes, server 11 is shown in the figure conceptually as a computer system with an antenna mounted on top.)

The network configuration of FIG. 1 also shows several enterprise VPN gateways —Enterprise-A gateways 12 and 13, connected to Enterprise-A VPN 19, and Enterprise-B gateway 14 connected to Enterprise-B VPN 20—through which an employee of the corresponding enterprise may access his or her enterprise's VPN (Intranet), as well as the rest of the Internet, symbolically shown as General Internet 15. Finally, FIG. 1 illustratively shows several wireless LAN users —user 16, user 17 and user 18—who are wirelessly connected to server 11.

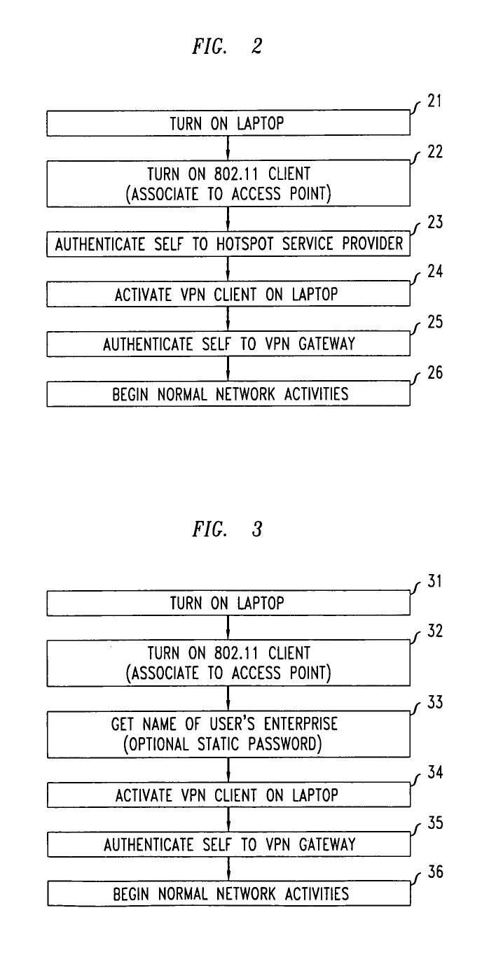

FIG. 2 shows a flowchart of a prior art method executed by a user for establishing a network connection to a Virtual Private Network through a wireless LAN hotspot. The method of FIG. 2 may, for example, be implemented in the example network of FIG. 1 by one of the users shown therein —user 16, user 17 or user 18. In particular, the given user first turns on his or her laptop computer as shown in block 21 of the flowchart. (Note that wireless LAN hotspots may be used by any of a number possible wireless LAN enabled devices including laptop or notebook computers, Personal Digital Assistants, and so forth—without loss of generality, the instant description will use the term “laptop computer” to encompass all such wireless LAN enabled devices.) Then, as shown in block 22 of the flowchart, he or she activates the 802.11 client resident on the laptop computer, or, alternatively, the laptop computer automatically activates the 802.11 client. (As is familiar to those skilled in the art, the 802.11 client is a software tool resident on any laptop computer which supports Wi-Fi wireless connectivity.) Once activated, the 802.11 client then associates to the “nearby” hotspot server (e.g., server 11 of FIG. 1) so that communication between the laptop computer and the hotspot server may be performed.

Next, the user authenticates himself or herself as a subscribed individual to the wireless LAN hotspot service provider, as shown in block 23 of the flowchart. In other words, the previously assigned user-name and password associated with the user's individual account with the given service provider is supplied to the hotspot server (e.g., server 11 of FIG. 1). This may be done using a conventional web browser, an 802.1x client, or other means familiar to those of ordinary skill in the art. (As is known to those skilled in the art, 802.1x is a common Wi-Fi authentication standard.)

Once authenticated to use the wireless LAN hotspot for general Internet access (and correspondingly, once the user's account to be billed for all such use has been identified by the hotspot service provider), the user activates his or her VPN client resident on the laptop computer, as shown in block 24 of the flowchart. As is well known to those skilled in the art, a VPN client is a software tool which enables the user to connect to the Virtual Private Network (i.e. the Intranet) of his or her enterprise from a network (e.g., Internet) location which is external thereto. In particular, the VPN client establishes a connection to one of the given enterprise's VPN gateways which will enable the user to gain access into the VPN (assuming that the user becomes authorized by the enterprise to do so).

Then, as shown in block 25 of the flowchart, the user authenticates himself or herself to the enterprise. That is, the user enters the user-name and password which have been assigned to the user by the enterprise. Thus, the enterprise VPN is able to verify that the user is an authorized individual (e.g., an employee of the enterprise) and is able to associate the necessary user information with the given connection. (Note that alternative authentication methods are also available. For example, rather than a combination of a user-name and a password, there are hardware tokens, RSA keypairs, and biometrics, to name a few. All of these are conventional and fully familiar to those skilled in the art.) Finally, as shown in block 26 of the flowchart, the user is able to begin normal network activities as if he or she were connected to the enterprise VPN from a location within the VPN.

As pointed out above, one of the disadvantages of using the above prior art method is the need for users to enroll with different wireless LAN hotspot service providers for widespread coverage. Moreover, each user must necessarily be billed individually for his or her usage of a given service provider's wireless LAN hotspots, despite the fact the a large majority of these users' incurred costs are business-related expenses that will ultimate be paid by a number of individual companies, where typically many customers will be reimbursed by the same company (i.e., enterprise).

A separate disadvantage of the prior art method is that the user has to authenticate himself or herself twice —once to the wireless LAN hotspot and once to the enterprise's VPN. This may not bother some users, but it can become a significant nuisance to the “road warrior” (i.e., an enterprise employee who spends a great deal of his or her time traveling and needs VPN access during those travels).

Thus, in accordance with a first illustrative embodiment of the present invention, the prior at method for establishing a network connection to a Virtual Private Network through a wireless LAN hotspot (such as the method shown in FIG. 2) is advantageously modified. In particular, rather than authenticating oneself (e.g., identifying oneself with user-name and password) to the wireless LAN hotspot service provider (as shown, for example, in block 23 of FIG. 2), the user only declares a particular enterprise name —presumably that of his or her employer. Then, instead of being awarded general Internet access after an authentication, the user (i.e., his or her laptop computer) is only enabled to exchange traffic with a restricted number of predetermined IP addresses —namely, those of the (known) VPN gateways of the given enterprise declared by the user.

Note that since these few particular IP addresses would not be of any value to most users, there is no incentive for anyone to improperly masquerade as an employee of the given enterprise (or for that matter, any other enterprise so supported by the given wireless LAN hotspot service provider in accordance with the principles of the present invention). Therefore, from the point of view of providing improper access, no initial authentication to the wireless LAN hotspot service provider is needed (i.e., block 23 of FIG. 2 can be advantageously eliminated). In accordance with this first illustrative embodiment of the present invention, the user-name normally (i.e., in accordance with the prior art method described above) provided may, for example, comprise simply the enterprise name, while the password normally provided may either be left blank or may be a simple static (i.e., fixed) phrase.

As such, in accordance with one illustrative embodiment of the present invention, the providing of the enterprise name and, if needed at all, the static password, may be advantageously made automatic and invisible to the user. That is, since the given user would be accessing only the one particular enterprise VPN of which he or she is an employee, the web browser or 802.1x client (see, e.g., the discussion of block 23 of FIG. 2 above) may be advantageously pre-configured to automatically provide the enterprise name as user-name and the aforementioned static phrase (or blank) as password to the hotspot server.

Note, of course, that the wireless LAN hotspot service provider will still wish to be able to bill for the connectivity provided. However, in accordance with the principles of the present invention, rather than dealing with thousands or millions of individual subscriber's accounts, the service provider may advantageously negotiate a bulk (perhaps flat-rate) agreement with each of a multitude of enterprises. At the same time as setting up such a billing arrangement, the service provider advantageously establishes the profile of IP addresses of the enterprise VPN gateways. Thus, in accordance with various illustrative embodiments of the present invention, significantly lower administrative costs may be advantageously achieved for the wireless LAN hotspot service provider. Moreover, the enterprise and its employees also advantageously benefit with lower administrative costs, since they can avoid detailed expense accounting and reimbursement.

Note also that no special software or new protocols are needed in the user's laptop computer. For example, standard 802.1x client software can be advantageously used, with any conventional software or operating system feature enabled for remembering the user-name (i.e., the enterprise name) and the password (i.e., the static phrase or blank). Clearly, the secrecy of those settings is not an issue, since the user will still need to sign on to his or her VPN before any (useful) access to the Internet can be obtained.

FIG. 3 shows a flowchart of a method executed by a user for establishing a network connection from to a Virtual Private Network through a wireless LAN hotspot operating in accordance with a first illustrative embodiment of the present invention. Like the prior art method of FIG. 2, the novel method of FIG. 3 may, for example, be implemented in the example network of FIG. 1 by one of the users shown therein —user 16, user 17 or user 18.

In particular, the given user first turns on his or her laptop computer as shown in block 31 of the flowchart. Then, as shown in block 32 of the flowchart, he or she activates the 802.11 client resident on the laptop computer, or, alternatively, the laptop computer automatically activates the 802.11 client. Once activated, the 802.11 client then associates to the “nearby” hotspot server (e.g., server 11 of FIG. 1) so that communication between the laptop computer and the hotspot server may be performed.

Next, however, and unlike the prior art method of FIG. 2, the user enters simply the name of his or her enterprise and a corresponding static “password” phrase (which is not really a password per se, since it is fixed and not secret and may even be blank), to identify the particular enterprise that he or she wishes to communicate with (and is, presumably, an employee of). (See block 33 of the flowchart.) As in the case of the prior art method of FIG. 2, this may be done using a conventional web browser, an 802.1x client, or other means familiar to those of ordinary skill in the art. This advantageously informs the wireless LAN hotspot service provider that the user is associated with (e.g., an employee of) the given enterprise. Thus, assuming that the wireless LAN hotspot provider has a prior billing arrangement with the given enterprise, the user will advantageously be given access to the VPN gateways of that enterprise, but will not be given access to the Internet in general.

As pointed out above, in accordance with another illustrative embodiment of the present invention, the illustrative method shown in the flowchart of FIG. 3 may be modified by removing block 33 in its entirety. In this other embodiment, the user's laptop computer may be advantageously pre-configured to automatically provide the enterprise name as user-name and the aforementioned static phrase (or blank) as password to the hotspot server.

Next (returning to the discussion of the illustrative embodiment of the present invention shown in FIG. 3), as in the prior art method of FIG. 2, the user activates his or her VPN client resident on the laptop computer, as shown in block 34 of the flowchart. In particular, the VPN client establishes a connection to one of the given enterprise's VPN gateways, which the wireless LAN hotspot service provider has allowed, and which will enable the user to gain access into the VPN (assuming that the user becomes authorized by the enterprise to do so).

Then, as shown in block 35 of the flowchart, the user authenticates himself or herself to the enterprise. That is, the user enters the user-name and password which have been assigned to the user by the enterprise. (Note that in accordance with other illustrative embodiments of the present invention, other alternative authentication methods may be used. For example, as pointed out above, rather than a combination of a user-name and a password, there are hardware tokens, RSA keypairs, and biometrics, to name a few. All of these are conventional and fully familiar to those skilled in the art.) Thus, the enterprise VPN is able to verify that the user is an authorized individual (e.g., an employee of the enterprise) and is able to associate the necessary user information with the given connection. Finally, as shown in block 36 of the flowchart, the user is able to begin normal network activities as if he or she were connected to the enterprise VPN from a location within the VPN.

FIG. 4 shows a flowchart of a method of operation of a wireless LAN hotspot server operating in accordance with the first illustrative embodiment of the present invention. The novel method of FIG. 4 may, for example, be implemented in wireless LAN hotspot service 11 shown in the example network configuration shown in FIG. 1. In particular, the wireless LAN hotspot server first receives an indication from a user (which may, for example, be one of the users shown in the example network configuration of FIG. 1—namely, user 16, user 17 or user 18) that he or she (i.e., the laptop computer or other wireless device) is connecting to the wireless LAN hotspot server, as shown in block 41 of the flowchart.

Next, the server receives a declaration of a particular enterprise name, as shown in block 42 of the flowchart, indicating that the given user wishes to connect to the VPN of the specified enterprise (e.g., because the user is an employee of that enterprise). The server may also receive a static (i.e., fixed) phrase as a password, or alternatively, a blank password, which the server may or not may verify the correctness thereof. In any event, in accordance with the principles of the present invention, the specified password, if any, does not serve to authenticate the user's identity, since the user is not identified (i.e., authenticated) in accordance with the illustrative embodiments of the present invention. Rather, in accordance with this first illustrative embodiment of the present invention, the user merely declares his or her intention to connect to the VPN of the specified enterprise (e.g., his or her association with the given enterprise).

Finally, based on the specified enterprise name, the wireless LAN hotspot server grants restricted Internet access to the user, as shown in block 43 of the flowchart. Specifically, the user is given the ability to exchange traffic with only a restricted number of predetermined IP addresses—namely, those of the VPN gateways of the given enterprise declared by the user. This list of IP addresses (for the given enterprise's VPN gateways) will have been advantageously predetermined by agreement between the wireless LAN hotspot service provider and the given enterprise.

In accordance with certain illustrative embodiments of the present invention, previously determined billing arrangements may be advantageously agreed upon between the wireless LAN hotspot service provider and the given enterprise. For example, it may be agreed that all wireless LAN access through the given service provider's hotspot(s) will be billed to the enterprise identified by the user (i.e., in block 42 of the flowchart of FIG. 4, described above). Since there is no point in a user specifying an enterprise with which he or she is not associated (i.e., an enterprise having a VPN into which the user will be unable to successfully gain access ), the enterprise should not be too concerned over charges incurred by users who are, in fact, not associated with the enterprise.

Alternatively, it may be agreed that all wireless access through the given service provider's hotspot(s) will be free until a user connects to a given enterprise's VPN gateway, or even until the user successfully gains access into the given enterprise's VPN. Again, since there is no point in a user (who does not have an individual account with the wireless service hotspot service provider as required, for example, by the prior art technique) making use of the wireless LAN hotspot service if he or she will not (quickly) gain access to the VPN of an enterprise, the wireless LAN hotspot service provider should not be concerned about the “free” wireless LAN access it is providing—it will be short-lived and/or pointless.

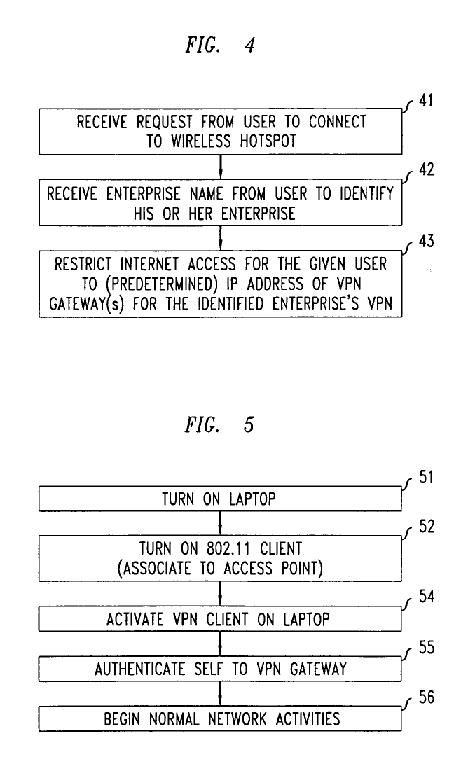

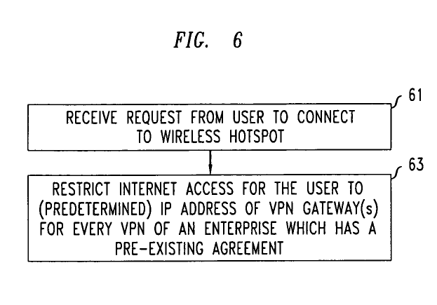

FIG. 5 shows a flowchart of a method executed by a user for establishing a network connection to a Virtual Private Network through a wireless LAN hotspot operating in accordance with a second illustrative embodiment of the present invention. Like the prior art method of FIG. 2 and the illustrative embodiment of the present invention shown in FIG. 3, the novel method of FIG. 5 may, for example, be implemented in the example network of FIG. 1 by one of the users shown therein —user 16, user 17 or user 18.

In particular, the given user first turns on his or her laptop computer as shown in block 51 of the flowchart. Then, as shown in block 52 of the flowchart, he or she activates the 802.11 client resident on the laptop computer, or, alternatively, the laptop computer automatically activates the 802.11 client. Once activated, the 802.11 client then associates to the “nearby” hotspot server (e.g., server 11 of FIG. 1) so that communication between the laptop computer and the hotspot server may be performed.

Next, however, and unlike either the prior art method of FIG. 2 or the illustrative embodiment of the present invention shown in FIG. 3, the user need not provide any identification information whatsoever —neither that of him—or herself as in the prior art method shown in FIG. 2, or that of an enterprise to whose VPN he or she wishes to gain access, as in the illustrative embodiment of the present invention shown in FIG. 3. Rather, in accordance with the second illustrative embodiment of the present invention, the wireless LAN hotspot service provider, which has, for example, made prior arrangements with a number of different enterprises, will advantageously allow any wireless LAN hotspot user access to the VPN gateways of any of these enterprises. Thus, as in the case of the first illustrative embodiment of the present invention shown in FIG. 3, and assuming that the wireless LAN hotspot provider has a prior billing arrangement with the given enterprise, the user will advantageously be given access to the VPN gateways of that enterprise, but will not be given access to the Internet in general.

Therefore, as shown in block 54 of the flowchart, the user next activates his or her VPN client resident on the laptop computer, just as in the first illustrative embodiment of the present invention shown in FIG. 3. In particular, the VPN client establishes a connection to one of the given enterprise's VPN gateways, which the wireless LAN hotspot service provider has allowed (since the wireless LAN hotspot service provider allows access to all enterprises with which it has a prior arrangement to do so), and which will enable the user to gain access into the VPN (assuming that the user becomes authorized by the enterprise to do so).

Then, as shown in block 55 of the flowchart, the user authenticates himself or herself to the enterprise. That is, the user enters the user-name and password which have been assigned to the user by the enterprise. (Note that in accordance with other illustrative embodiments of the present invention, other alternative authentication methods may be used. For example, as pointed out above, rather than a combination of a user-name and a password, there are hardware tokens, RSA keypairs, and biometrics, to name a few. All of these are conventional and fully familiar to those skilled in the art.) Thus, the enterprise VPN is able to verify that the user is an authorized individual (e.g., an employee of the enterprise) and is able to associate the necessary user information with the given connection. Finally, as shown in block 56 of the flowchart, the user is able to begin normal network activities as if he or she were connected to the enterprise VPN from a location within the VPN.

FIG. 6 shows a flowchart of a method of operation of a wireless LAN hotspot server operating in accordance with the second illustrative embodiment of the present invention. Like the first illustrative embodiment of the present invention shown in FIG. 4, the novel method of FIG. 6 may, for example, be implemented in wireless LAN hotspot service 11 shown in the example network configuration shown in FIG. 1. In particular, the wireless LAN hotspot server first receives an indication from a user (which may, for example, be one of the users shown in the example network configuration of FIG. 1—namely, user 16, user 17 or user 18) that he or she (i.e., the laptop computer or other wireless device) is connecting to the wireless LAN hotspot server, as shown in block 61 of the flowchart.

However, unlike the first illustrative embodiment of the present invention, the server does not receive any declaration of a particular enterprise name. Rather, as shown in block 63 of the flowchart, the wireless LAN hotspot server “automatically” grants restricted Internet access to the user. Specifically, the user is given the ability to exchange traffic with only a restricted number of predetermined IP addresses —namely, those of the VPN gateways of any and all enterprises with which the wireless LAN hotspot service provider has a previously agreed upon arrangement. In particular, this list of IP addresses will comprise a combination of the lists of IP addresses representative of the VPN gateways of each of the enterprises with such an agreement. Each of these lists will have been advantageously provided in advance by the given enterprise.

Note that in accordance with certain illustrative embodiments of the present invention in which the method of FIGS. 5 and 6 are employed, previously determined billing arrangements which have been advantageously agreed upon between the wireless LAN hotspot service provider and the various enterprises may advantageously be of the second type described above (in connection with the description of the first illustrative embodiment of the present invention shown in FIGS. 3 and 4). That is, it may be agreed that all wireless access through the given service provider's hotspot(s) will be free until a user connects to a given enterprise's VPN gateway, or until the user successfully gains access into the given enterprise's VPN. Again, since there is no point in a user (who does not have an individual account with the wireless service hotspot service provider as required, for example, by the prior art technique) making use of the wireless LAN hotspot service if he or she will not (quickly) gain access to the VPN of an enterprise, the wireless LAN hotspot service provider should not be concerned about the “free” wireless LAN access it is providing—it will be short-lived and/or pointless.

And in accordance with certain illustrative embodiments of the present invention, usage-sensitive billing may advantageously be charged by the wireless LAN hotspot service provider to each given enterprise on the basis of collected traffic statistics. That is, if the wireless LAN hotspot service provider wishes to charge on a usage-sensitive basis, it may do so by merely determining the amount of traffic going to each enterprise address.

Note that each of the above illustrative embodiments of the present invention may be achieved by providing certain added functionality in the wireless LAN hotspot server (e.g., wireless LAN hotspot server 11 shown in FIG. 1). In particular, the hotspot server merely filters packets according to rule sets which are advantageously restricted by source/destination IP address pairs. That is, a given user will only be allowed to exchange packets between his or her laptop computer and one of the VPN gateways of his or her enterprise (in accordance with the first illustrative embodiment of the present invention as shown in FIGS. 3 and 4), or between his or her laptop computer and one of the VPN gateways of any of the enterprises with which the wireless LAN hotspot service provider has a prearrangement to do so (in accordance with the second illustrative embodiment of the present invention as shown in FIGS. 5 and 6). The implementation of such a capability will be clear to one of ordinary skill in the art, since it is routinely available from conventional firewalls today and will be easily achievable for the numbers of clients (i.e., users) who will be active at any one time within a given wireless LAN hotspot.

Although the illustrative embodiments of the present invention which have been described above have been primarily directed to wireless LAN hotspot environments, the principles of the present invention are equally applicable to wired network access environments as well. That is, other illustrative embodiments of the present invention may be employed to provide user network access in a similar advantageous manner in conference rooms or hotel rooms in which (fee-based) guest network access is provided to users physically located therein. In both cases (i.e., wireless and wired), a network access server provides the network access service to the users—either wirelessly (via a wireless connection such as, for example, IEEE 802.11), or through a conventional wired connection.

In addition, although the illustrative embodiments of the present invention which have been described above have been primarily directed to providing (limited) network access by a user to one or more enterprise VPN gateways, the principles of the present invention are equally applicable to providing (limited) network access to other enterprise-authenticated hosts. That is, other illustrative embodiments of the present invention may be employed to provide user network access by a user in a similar advantageous manner to other secure hosts, including, for example, “HTTPS” servers.

### Addendum to the detailed description

It should be noted that all of the preceding discussion merely illustrates the general principles of the invention. It will be appreciated that those skilled in the art will be able to devise various other arrangements, which, although not explicitly described or shown herein, embody the principles of the invention, and are included within its spirit and scope. In addition, all examples and conditional language recited herein are principally intended expressly to be only for pedagogical purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. It is also intended that such equivalents include both currently known equivalents as well as equivalents developed in the future—i.e., any elements developed that perform the same function, regardless of structure.

1. A method for establishing a connection from a user terminal to a network through a network access server, the method comprising the steps of:
receiving a request from the user terminal to access the network with use of the network access server; and
providing limited network access to the user terminal through the network access server, wherein providing said limited network access comprises providing network connectivity through said network access server between said user terminal and one or more predetermined enterprise-authenticated hosts and not providing network connectivity through said network access server between said user terminal and network sites other than said one or more predetermined enterprise-authenticated hosts.

2. The method of claim 1 wherein the user terminal comprises a wireless device and the network access server comprises a wireless LAN hotspot server.

3. The method of claim 2 wherein the wireless device and the wireless LAN hotspot server communicate with use of an IEEE 802.11 standard protocol.

4. The method of claim I wherein said request from the user terminal comprises an identification of a given enterprise, and wherein said one or more enterprise-authenticated hosts consists of one or more VPN gateways associated with said given enterprise.

5. The method of claim 4 wherein said user terminal has been pre-configured to automatically provide said identification of the given enterprise.

6. The method of claim 4 wherein said request from the user terminal further comprises a fixed password, said fixed password uniquely associated with said given enterprise.

7. The method of claim 6 wherein said user terminal has been pre-configured to automatically provide said identification of the given enterprise and said fixed password.

8. The method of claim 4 wherein said network access server is operated by a service provider, and wherein said service provider and said given enterprise have a pre-existing relationship.

9. The method of claim 8 wherein said pre-existing relationship comprises an agreement that said limited network access provided to said user terminal incurs a charge billed by said service provider to said given enterprise.

10. The method of claim 1 wherein said network access server is operated by a service provider, wherein said service provider has a pre-existing relationship with each of one or more known enterprises, and wherein said one or more enterprise-authenticated hosts consists of one or more VPN gateways associated with each of said one or more known enterprises.

11. The method of claim 10 wherein each of said pre-existing relationships comprises an agreement that said limited network access provided to said user terminal incurs a charge billed by said service provider to a corresponding one of said one or more known enterprises.

12. The method of claim 1 wherein said step of providing said limited network access comprises the steps of:
comparing a first IP address pair to a set of previously stored IP address pairs, the first IP address pair comprising an IP address of said user terminal and an IP address of an intended destination to which access has been requested by said user terminal, and each IP address pair in the set of previously stored IP address pairs comprising the IP address of a user terminal connected to said network access server and an IP address of one of said one or more enterprise-authenticated hosts; and
providing network connectivity between said user terminal and said intended destination if and only if said first IP address pair matches one of said IP address pairs in said set of previously stored IP address pairs.

13. A network access server for establishing a connection from a user terminal to a network, the network access server comprising:
means for receiving a request from the user terminal to access the network with use of the network access server; and
means for providing limited network access to the user terminal through the network access server, wherein providing said limited network access comprises providing network connectivity through said network access server between said user terminal and one or more predetermined enterprise-authenticated hosts and not providing network connectivity through said network access server between said user terminal and network sites other than said one or more predetermined enterprise-authenticated hosts.

14. The network access server of claim 13 wherein the user terminal comprises a wireless device and the network access server comprises a wireless LAN hotspot server.

15. The network access server of claim 14 wherein the wireless device and the wireless LAN hotspot server communicate with use of an IEEE 802.11 standard protocol.

16. The network access server of claim 13 wherein said request from the user terminal comprises an identification of a given enterprise, and wherein said one or more enterprise-authenticated hosts consists of one or more VPN gateways associated with said given enterprise.

17. The network access server of claim 16 wherein said user terminal has been pre-configured to automatically provide said identification of the given enterprise.

18. The network access server of claim 16 wherein said request from the user terminal further comprises a fixed password, said fixed password uniquely associated with said given enterprise.

19. The network access server of claim 18 wherein said user terminal has been pre-configured to automatically provide said identification of the given enterprise and said fixed password.

20. The network access server of claim 16 wherein said network access server is operated by a service provider, and wherein said service provider and said given enterprise have a pre-existing relationship.

21. The network access server of claim 20 wherein said pre-existing relationship comprises an agreement that said limited network access provided to said user terminal incurs a charge billed by said service provider to said given enterprise.

22. The network access server of claim 13 wherein said network access server is operated by a service provider, wherein said service provider has a pre-existing relationship with each of one or more known enterprises, and wherein said one or more enterprise-authenticated hosts consists of one or more VPN gateways associated with each of said one or more known enterprises.

23. The network access server of claim 22 wherein each of said pre-existing relationships comprises an agreement that said limited network access provided to said user terminal incurs a charge billed by said service provider to a corresponding one of said one or more known enterprises.

24. The network access server of claim 13 wherein said step of providing said limited network access comprises the steps of:
comparing a first IP address pair to a set of previously stored IP address pairs, the first IP address pair comprising an IP address of said user terminal and an IP address of an intended destination to which access has been requested by said user terminal, and each IP address pair in the set of previously stored IP address pairs comprising the IP address of a user terminal connected to said network access server and an IP address of one of said one or more enterprise-authenticated hosts; and
providing network connectivity between said user terminal and said intended destination if and only if said first IP address pair matches one of said IP address pairs in said set of previously stored IP address pairs.
